(19) United States
(12) Patent Application Publication
(10) Pub. No.: US 2026/0336728 A1
(43) Pub. Date: Oct. 29, 2026

(54) SYSTEMS AND METHODS FOR IMPROVING A STABILITY OF AN UNMANNED VEHICLE HAVING A MOVEABLE MASS

(71) Applicant: ROCKWELL AUTOMATION CANADA LTD., Cambridge (CA)

(72) Inventors: Robert DAM, Kitchener (CA); Ryan Christopher GARIEPY, Waterloo (CA); Nolan LUNSCHER, Kitchener (CA); Jason MERCER, Kitchener (CA); Devjit NAHA, Burlington (CA); Michael-Anthony TEDESCO, Toronto (CA)

(21) Appl. No.: 19/188,214

(22) Filed: Apr. 24, 2025

(51) Int. Cl. B62D 37/04

(52) U.S. Cl. CPC B62D 37/04

(57) ABSTRACT

Systems and methods of improving a stability of an unmanned vehicle having a moveable mass. The method involves operating a processor to: determine an initial center of gravity for the unmanned vehicle, the moveable mass being at an initial position; monitor an operating state of the unmanned vehicle for an instability condition; in response to detecting an instability condition, determine a corrective response at the moveable mass for maintaining the stability at the unmanned vehicle; and apply the corrective response to the moveable mass to maintain the stability of the unmanned vehicle by moving the moveable mass from the initial position.

### FIELD

The described embodiments relate to systems and methods for improving a stability of an unmanned vehicle having a moveable mass. In particular, the systems and methods relate to reconfiguring an unmanned vehicle to increase stability while turning.

### BACKGROUND

Unmanned vehicles are designed such that they are both safe and efficient during operation. Advanced safety systems responsible for controlling distinct aspects of the vehicle can be installed to increase the vehicle’s stability. For example, electronic stability control systems help maintain a vehicle’s control during extreme steering maneuvers and traction control systems prevent wheel spin during acceleration to enhance stability on slippery surfaces.

However, increasing safety systems can limit the efficiency of an unmanned vehicle. For example, vehicles can be configured to take turns under specific linear and angular velocity combinations (i.e., within defined stable operating regions) to prevent instability conditions, such as vehicle tipping, from occurring. These preset safety configurations are generalized and are often applied conservatively.

### SUMMARY

The various embodiments described herein generally relate to systems and methods improving a stability of an unmanned vehicle having a moveable mass.

In accordance with an example embodiment, there is provided a method of improving a stability of an unmanned vehicle having a moveable mass. The method involves operating a processor at the unmanned vehicle to: determine an initial center of gravity for the unmanned vehicle, the moveable mass being at an initial position; monitor an operating state of the unmanned vehicle for an instability condition; in response to detecting an instability condition, determine a corrective response at the moveable mass for maintaining the stability at the unmanned vehicle; and apply the corrective response to the moveable mass to maintain the stability of the unmanned vehicle by moving the moveable mass from the initial position.

In some embodiments, operating the processor to monitor for an instability condition includes determining a stable operating region for the unmanned vehicle; and determining the operating state of the unmanned vehicle fails to satisfy the stable operating region.

In some embodiments, operating the processor to monitor for an instability condition includes collecting sensor data by one or more sensors coupled to the unmanned vehicle and in communication with the processor.

In some embodiments, operating the processor at the unmanned vehicle includes receiving mission data.

In some embodiments, operating the processor to monitor the operating state of the unmanned vehicle for an instability condition includes identifying an action from the received mission data, the action, when performed, triggers the instability condition.

In some embodiments, in response to identifying the action, when performed, triggers the instability condition, includes operating the processor to: determine a corrective response at the moveable mass to maintain the stability of the unmanned vehicle; and apply the corrective response to the moveable mass prior to performing the action.

In some embodiments, the mission data includes historical data defining one or more unstable locations.

In some embodiments, in response to detecting an instability condition, operating the processor to determine a corrective response at the moveable mass for maintaining stability of the unmanned vehicle includes applying the corrective response prior to entering the one or more unstable locations.

In some embodiments, operating the processor to apply the corrective response to the moveable mass includes activating an actuator secured to the unmanned vehicle.

In some embodiments, the moveable mass is a payload secured to the unmanned vehicle.

In accordance with an example embodiment, there is provided a system of improving a stability of an unmanned vehicle having a moveable mass. The system includes a processor configured to: determine an initial center of gravity for the unmanned vehicle, the moveable mass being at an initial position; monitor an operating state of the unmanned vehicle for an instability condition; in response to detecting an instability condition, determine a corrective response at the moveable mass for maintaining the stability at the unmanned vehicle; and apply the corrective response to the moveable mass to maintain the stability of the unmanned vehicle by moving the moveable mass from the initial position.

In some embodiments, monitoring the operating state of the unmanned vehicle for an instability condition includes operating the processor to: determine a stable operating region for the unmanned vehicle; and determine the operating state of the unmanned vehicle fails to satisfy the stable operating region.

In some embodiments, monitoring for an instability condition includes operating the processor to collect sensor data by one or more sensors coupled to the unmanned vehicle and in communication with the processor.

In some embodiments, the processor at the unmanned vehicle is operable to receive mission data.

In some embodiments, monitoring the state of the unmanned vehicle for an instability condition includes operating the processor to identify an action from the received mission data, the action, when performed, triggers the instability condition.

In some embodiments, in response to identifying the action, when performed, triggers the instability condition, includes operating the processor to: determine a corrective response at the moveable mass to maintain the stability of the unmanned vehicle; and apply the corrective response to the moveable mass prior to performing the action.

In some embodiments, the mission data includes historical data defining one or more unstable locations.

In some embodiments, in response to detecting an instability condition, determining a corrective response at the moveable mass for maintaining stability of the unmanned vehicle includes operating the processor to apply the corrective response prior to entering the one or more unstable locations.

In some embodiments, applying the corrective response to the moveable mass includes operating the processor to activate an actuator secured to the unmanned vehicle.

In some embodiments, the moveable mass is a payload secured to the unmanned vehicle.

### BRIEF DESCRIPTION OF THE DRAWINGS

Several embodiments will now be described in detail with reference to the drawings, in which:

FIG. 1 is a block diagram of unmanned vehicles in communication with a system data storage, in accordance with an at least one embodiment;

FIG. 2 is a block diagram of an example unmanned vehicle, in accordance with at least one embodiment;

FIG. 3 is a block diagram of an example unmanned vehicle, in accordance with an at least one embodiment;

FIG. 4 is a flowchart illustrating an example method for increasing the stability of an unmanned vehicle having a moveable mass, in accordance with at least one embodiment;

FIG. 5 is a diagram illustrating an example of a stable operating region for an unmanned vehicle, in accordance with at least one embodiment;

FIG. 6A a block diagram of an example unmanned vehicle having a moveable mass, in accordance with at least one embodiment

FIG. 6B is a block diagram of an example unmanned vehicle having a moveable mass, in accordance with at least one embodiment; and

FIG. 7 is an illustration of an example unmanned vehicle turning with a moveable mass to increase stability, in accordance with at least one embodiment.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXAMPLE EMBODIMENTS

A major factor contributing to the safety of a vehicle is its stability during operation. The stability of a vehicle can be determined with relation to the drive and/or support wheels, in relation to the center of gravity. The center of gravity can affect, for example, the tipping stability of the vehicle, the traction stability of the drive wheels, and the traction stability of the vehicle as a whole. A vehicle operating outside of its stable operating region for its current center of gravity can lead to instability resulting in tipping of the vehicle, loss of drive traction of one or more drive wheel causing the vehicle to lose control, or loss of turning traction causing the vehicle to skid.

To increase safety, unmanned vehicles have been designed with systems to increase its stability passively. For example, suspension systems are added to vehicles to allow for increased down force on a subset of the wheels when accelerating or braking, which increases traction on the steering wheels in question. However, these passive systems are unable to account for the shifting dynamics of a vehicle in operation, such as correcting for a vehicle attempting a turn too quickly for its center of gravity.

Further, passive systems are only configured to prevent instability conditions reactively. In other words, such systems are unable to adapt to a changing environment or proactively respond to anticipated instability conditions. For example, the terrain a vehicle navigates may change over time. Traction on floors may degrade through repeated use, and areas which were once considered safe could become potentially dangerous over time. Additionally, the vehicle may attempt a turn at an operating state (i.e., linear and angular velocity combination) outside what is stable for the center of gravity of the vehicle. Accordingly, vehicles designed with systems that only increase stability passively may not be able to properly adapt to changing floor conditions or operating states.

The embodiments described herein provide systems and methods for improving a stability of an unmanned vehicle having an moveable mass. The described embodiments can monitor the operating state of the vehicle for an instability condition and determine a corrective response at the moveable mass to maintain the stability of the unmanned vehicle. The described embodiments can improve the stability of an unmanned vehicle in various scenarios, such as for example, when the unmanned vehicle is turning or when the unmanned vehicle is traveling unstable floors (e.g., slippery or having loose particulate).

Accordingly, the systems and methods present a solution which can increase the operating envelope of an unmanned vehicle allowing for turn-speed combinations that could otherwise create an instability condition, increase the size of an unmanned vehicle’s payload stability triangle (while keeping the operating envelope the same), or incorporate some combination thereof.

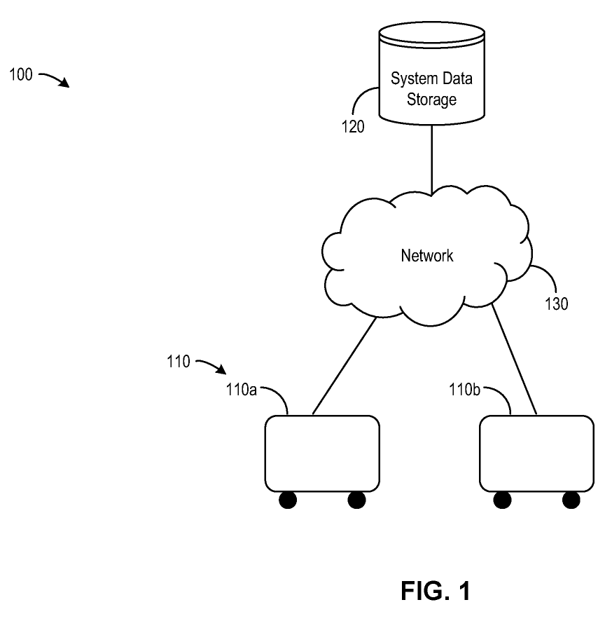

Reference is first made to FIG. 1, which illustrates a block diagram 100 which shows a block diagram 100 illustrating unmanned vehicles 110a, 110b (collectively referred to as the unmanned vehicles 110) in communication with a storage data system 120 via a network 130. While FIG. 1 shows examples of unmanned vehicles 110a, 110b for illustrative purposes, fewer or more unmanned vehicles 110 can operate with the system data storage 120.

The storage data system 120 can store data related to the unmanned vehicles 110. The system data storage can include RAM, ROM, one or more hard drives, one or more flash drives or some other suitable data storage elements such as disk drives, etc. For example, the system data storage 120 can store electronic maps related to the operating environment of the unmanned vehicles 110. The electronic maps located on the system data storage 120 can be accessible for download, via the network, by the unmanned vehicles 110.

The network 130 may be any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between the unmanned vehicles 110, and the system data storage 120. In some embodiments, the unmanned vehicles 110 can communicate with each other via the network 120. In some embodiments, vehicle 110a can communicate with vehicle 110b directly via onboard communication components. In some embodiments, the system data storage can be onboard the unmanned vehicle 110.

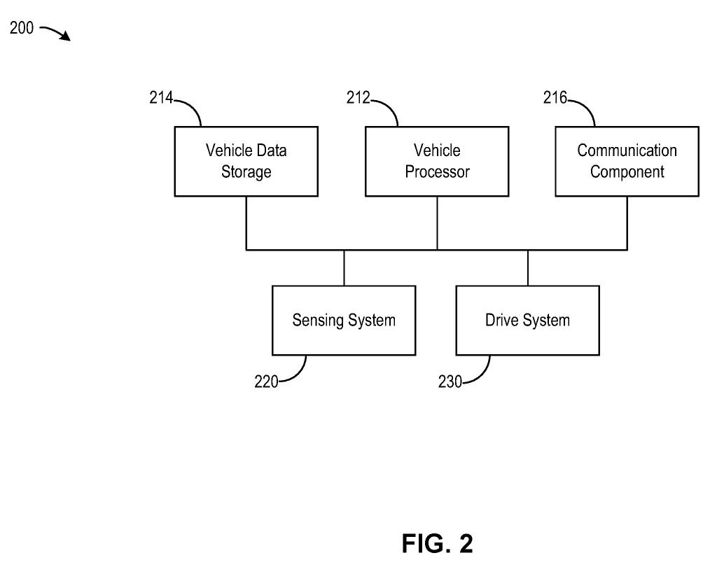

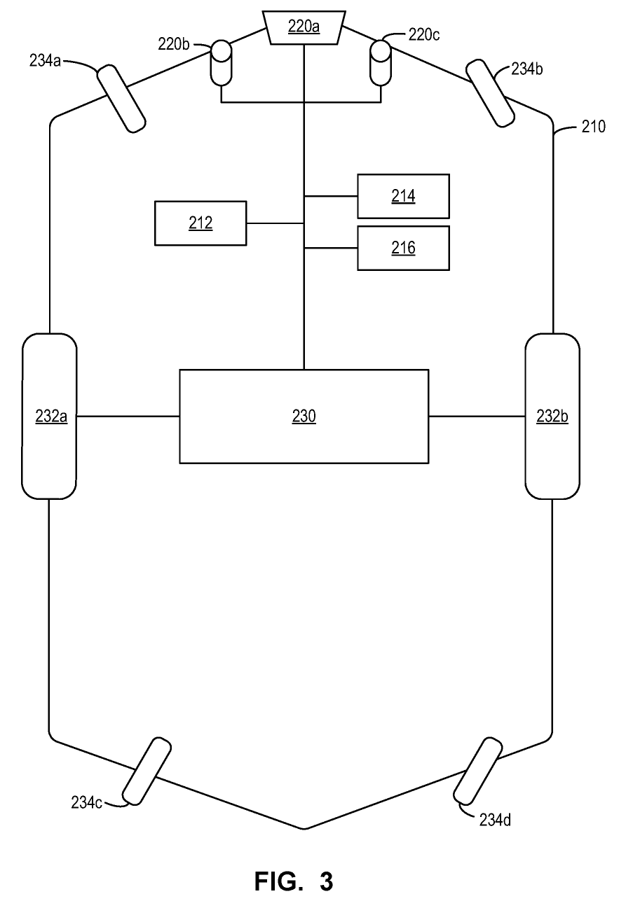

Reference is now made to FIG. 2, which illustrates a block diagram of an example unmanned vehicle 210. The unmanned vehicle 210 can include a vehicle processor 212, a vehicle data storage 214, a communication component 216, a sensing system 220, and a drive system 230. Components 212, 214, 216, 220, and 230 are illustrated separately in FIG. 3, for ease of exposition. In some embodiments, one or more of the components 212, 214, 216, 220, and 230 can be combined into fewer components, or separated into further components. In some embodiments, parts of a component can be combined with another part of another component.

The vehicle processor 212 can include any suitable processor, controller or digital signal processor that can provide sufficient processing power depending on the configuration, purposes and requirements of the unmanned vehicle 210. In some embodiments, the vehicle processor 212 can include more than one processor with each processor being configured to perform different dedicated tasks.

The vehicle processor 212 can operate the vehicle data storage 214, the communication component 216, the sensing system 220, and the drive system 230. For example, the vehicle processor 212 can operate the sensing system 220 to detect a terrain change from sensor data collected by one or more sensors coupled to the unmanned vehicle 210 and in communication with the vehicle processor 212. The vehicle processor 212 can also control the vehicle data storage 214, the communication component 216, the sensing system 220, and the drive system 230, as necessary. The operation of the vehicle processor 212 can be based on data collected from the vehicle data storage 214, the communication component 216, the sensing system 220, and/or the drive system 230, in some embodiments.

The vehicle data storage 214 can include RAM, ROM, one or more hard drives, one or more flash drives, or some other suitable data storage elements such as disk drives, etc. For example, the vehicle data storage 214 can include volatile and non-volatile memory. Non-volatile memory can store computer programs consisting of computer-executable instructions, which can be loaded into the volatile memory for execution by the vehicle processor 212. Operating the vehicle processor 212 to carry out a function can involve executing instructions (e.g., a software program) that can be stored in the vehicle data storage 214 and/or transmitting or receiving inputs and outputs via the communication component 216. The vehicle data storage 214 can also store data input to, or output from, the vehicle processor 212, which can result from the course of executing the computer-executable instructions for example.

In some embodiments, the vehicle data storage 214 can store data related to the operation of the unmanned vehicle 210, such as one or more electronic maps of its operating environment and/or operating parameters. The vehicle data storage 214 can store data tables, data processing algorithms (e.g., image processing algorithms), as well as other data and/or operating instructions which can be used by the vehicle processor 212.

The communication component 216 can include any interface that enables the unmanned vehicle 210 to communicate with other components, and external devices and systems. In some embodiments, the communication component 216 can include at least one of a serial port, a parallel port or a USB port. The communication component 216 may also include a wireless transmitter, receiver, or transceiver for communicating with a wireless communications network (e.g. using an IEEE 802.11 protocol or similar). The wireless communications network can include at least one of an Internet, Local Area Network (LAN), Ethernet, Firewire, modem or digital subscriber line connection. Various combinations of these elements may be incorporated within the communication component 216. For example, the communication component 216 may receive input from various input devices, such as a mouse, a keyboard, a touch screen, a thumbwheel, a track-pad, a track-ball, a card-reader, voice recognition software and the like depending on the requirements and implementation of the unmanned vehicle 210.

The communication component 216 can receive information about obstacles and/or unexpected objects located in the vehicle’s operating environment directly or indirectly from the system data storage 120 or from other vehicles within the same operating environment, via the network 130. The vehicle processor 212 may also transmit, via the communication component 216.

The sensing system 220 can monitor the environment of the unmanned vehicle 210. The sensing system 220 can include one or more sensors for capturing information related to the environment. The information captured by the sensing system 220 can be applied for various purposes, such as, but not limited to, localization, navigation and/mapping. For example, the sensing system 220 can include, but not limited to, optical sensors equipped with depth perception capabilities, infrared (IR) capabilities, or sonar capabilities. The optical sensors can include imaging sensors (e.g., photographic and/or video cameras), and range-finding sensors (e.g., time of flight sensors, Light Detection and Ranging (LiDAR) devices which generate and detect reflections of pulsed laser from objects proximal to the unmanned vehicle 210, etc.). The sensing system 220 can also include navigational sensors, such as ground positioning system (GPS) sensors, as well as sensors that detect guiding infrastructure installed within the operating environment. Example sensors that detect guiding infrastructure can include, but not limited to, magnetic sensors that detect magnetic tape within a facility warehouse, and/or optical sensors that detect visual navigational indicators within the operating environment.

The sensing system 220 can also include one or more sensors for monitoring the various components and subcomponents of the unmanned vehicle 210. In some embodiments, the sensing system can monitor the vehicle control system, the drive system 230, and/or subcomponents thereof. For example, the sensing system 220 may include, but is not limited to, sensors for measuring voltage, current, velocity, acceleration, and/or temperature.

In some embodiments, the sensing system 220 can include a sensing processor that receives data collected by the sensors and processes the collected data. The sensing processor can operate independently from the vehicle processor 212. In some other embodiments, the sensing system 220 can receive the data collected by sensors and transmit the collected data to the vehicle processor 212 for further processing.

The vehicle processor 212 can receive the data collected by the sensing system 220 and can apply the collected data to assist with navigating the unmanned vehicle 210 within its operating environment. For example, the vehicle processor 212 can receive environment data from the sensing system 220 in respect of the environment (e.g., a landmark) and can cross-reference the received environment data against the electronic map to assist with localizing the unmanned vehicle 210 and to navigate the unmanned vehicle 210 accordingly. The vehicle processor 212 can also use data collected by the sensing system 220 to determine locations for load pick-up and drop-off. For example, the sensing system 220 can collect data related to visual markers associated with pick-up and drop-off locations. The sensing system 220 can then transmit the collected data to the vehicle processor 212 for processing or can determine the associated location before transmitting the location data to the vehicle processor 212. Example visual indicators can include, but not limited to, corner tape or graphic patterns placed on the ground for identifying the pick-up or drop-off location. In some examples, the sensing system 220 can include optical sensors and/or LiDAR sensors operable for detecting the visual indicators.

The sensing system 220 can also assist the vehicle processor 212 with executing action commands. For example, when executing the action command related to a load pick-up, the sensing system 220 can operate to collect image data related to the environment of the unmanned vehicle 210 to assist the vehicle processor 212 with identifying the load and orienting with respect to the load for the pick-up.

In some embodiments, the sensing system 220 can be operated to monitor the operating environment of the unmanned vehicle 210 for the purpose of minimizing and/or avoiding collisions.

The sensing system 220 can include sensors dedicated for collision avoidance, in some embodiments, or can use existing sensors within the sensing system 220 for collision avoidance. In contrast with sensor data required for localization, navigation and/or mapping, the sensor data required for collision avoidance can be lower resolution. For example, sensors such as LiDAR devices and time-of-flight sensors can generate robust signals that can be quickly transmitted and processed, which can be important for collision avoidance. In some embodiments, the vehicle processor 212 can use the data collected from the sensing system 220 for avoidance detection, even though the sensor data may be higher-resolution and requires more processing time.

The vehicle processor 212 can operate the sensing system 220 to detect an obstacle within the operating environment. In response to detecting the obstacle, the vehicle processor 212 can implement a collision avoidance operation to minimize, or prevent, a collision between the unmanned vehicle 210 and the detected obstacle. Examples of collision avoidance operations can include, but are not limited to, controlling the drive system 230 to immediately stop the vehicle, cutting the power to the vehicle motor, or avoidance steering.

The sensing system 220 can also include the sensing processor in some embodiments, to assist with collision avoidance. For example, the sensing processor can receive data collected by the sensors to determine whether a collision is imminent and operate one or more collision avoidance operations. The sensing processor can include a low-level processor, such as a programmable logic controller (PLC). The PLC or other real-time controller can also be integrated with the vehicle processor 212 and used in conjunction with a higher-level processor. The sensing processor can receive, and process low-level signals generated by the sensors, and in turn, can transmit low-level output logic signals to control the drive system 230 to implement a collision avoidance operation.

The drive system 230 can include the components required for steering, driving, and stopping the unmanned vehicle 210. For example, the drive system can include a steering component and a drive motor. Specifically, the drive system 230 may include a motor and/or brakes connected to drive wheels 232a and 232b for driving the unmanned vehicle 210, as shown in FIG. 3. The motor can be, but is not limited to, an electric motor, a combustion engine, or a combination/hybrid thereof. Depending on the application of the unmanned vehicle 210, the drive system 230 may also include control interfaces that can be used for controlling the drive system 230. For example, the drive system 230 may be controlled to drive the drive wheel 232a at a different speed than the drive wheel 232b in order to turn the unmanned vehicle 210. Different embodiments may use different numbers of drive wheels, such as one, two, three, four, etc.

As shown in FIG. 3, a number of additional wheels 234 may be included. The unmanned vehicle 210 includes wheels 234a, 234b, 234c, and 234d. The wheels 234 may be wheels that are capable of allowing the unmanned vehicle 210 to turn, such as castors, steered wheels, or mecanum wheels. In some embodiments, the autonomous mobile robot 210 can be equipped with special tires for rugged surfaces or particular floor surfaces unique to its environment.

The sensing system 220 in FIG. 2 includes example vehicle sensors 220a, 220b, and 220c, as shown in FIG. 3. The sensors 220a, 220b, 220c can include, but are not limited to, optical sensors arranged to provide three-dimensional (e.g., binocular or RGB-D) imaging, two-dimensional laser scanners, and three-dimensional laser scanner.

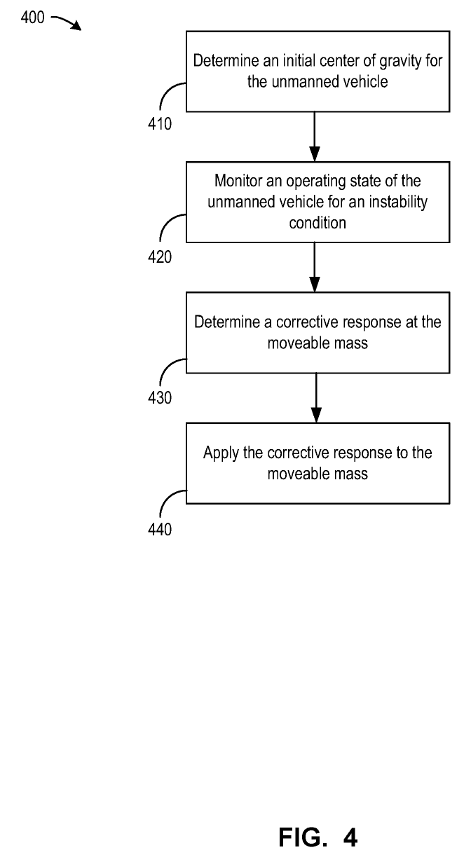

Referring now to FIG. 4, there is shown an example method 400 for improving a stability of an unmanned vehicle having a moveable mass.

Unmanned vehicles can be, for example, self-driving vehicles (e.g., autonomous mobile robots), automated guided vehicles, or vehicles broadly (e.g., industrial trucks, sea vessels, road vehicles, etc.).

The moveable mass can be for example, a high-density material such as but not limited to lead, iron, or concrete, sized to fit within the unmanned vehicle 210. In some embodiments, the moveable mass is housed within an internal compartment within the unmanned vehicle 210. The moveable mass can be any shape or form suitable to affect the center of gravity of the unmanned vehicle 210 when the moveable mass is moved. For example, the moveable mass can be shaped as a cube, a sphere, a cylinder, a cone, or a pyramid. The moveable mass can also be a fluid, magnetic, or otherwise. In some embodiments, the moveable mass can be a payload secured to the unmanned vehicle 210 that the vehicle is transporting.

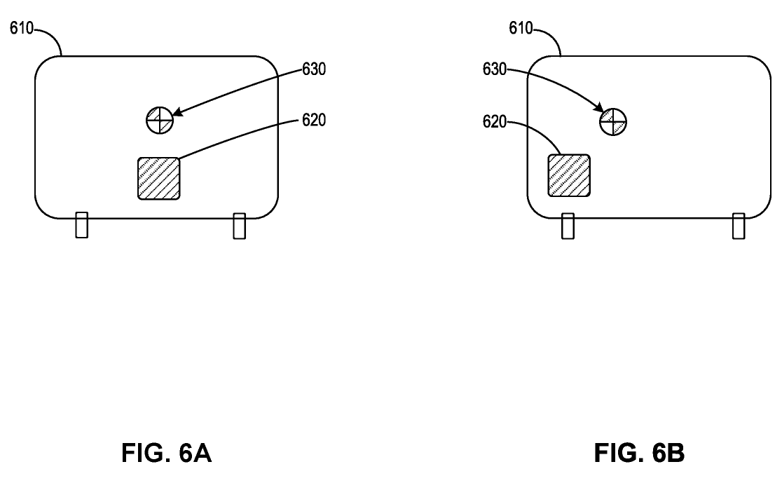

Referring to FIG. 6A, a front view of an example unmanned vehicle 610 is shown having a moveable mass 620 at an initial position within the unmanned vehicle 610. The unmanned vehicle 610 and moveable mass 620 have a combined center of gravity 630. In FIG. 6A, the moveable mass 620 is within the vehicle. It will be understood that the moveable mass may be external to the unmanned vehicle 610. For example, the moveable mass 620 can be a payload secured to the unmanned vehicle 610.

The method begins at 410, where the vehicle processor 212 determines an initial center of gravity for the unmanned vehicle 210. The unmanned vehicle 210 has a moveable mass at an initial position. In some instances, at the point of determining the initial center of gravity, the unmanned vehicle 210 is in a stable operating state. A stable operating state for an unmanned vehicle 210 can be defined, for example, by the unmanned vehicle’s 210 stable operating region. A stable operating region can be defined, for example, as combinations of linear velocity and angular velocity the unmanned vehicle 210 can operate within while remaining stable for a given center of gravity. In some embodiments, during a stable operating state, the moveable mass can be fixed in its initial position.

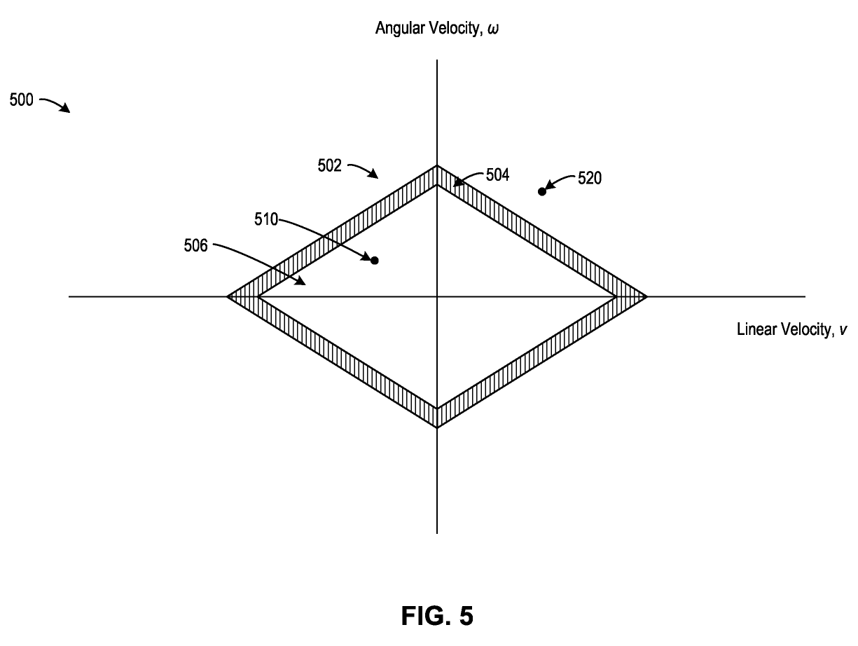

Referring to FIG. 5, a diagram 500 illustrates an example of stable operating region 502 for an unmanned vehicle. Generally, for each unmanned vehicle, a stable operating region 502 can be defined to identify a boundary within which that unmanned vehicle can operate at a stable condition. This stable operating region 502 may vary for different unmanned vehicles depending on various factors, including, but not limited to, their intended operating environment(s), the vehicle characteristics and/or intended load types. A fleet management system may automatically determine the stable operating region 502 for each unmanned vehicle and/or one or more groups of unmanned vehicles depending on intended missions and/or tasks. For example, in FIG. 5, the stable operating region 502 corresponds to an unmanned vehicle having a given center of gravity. In some embodiments, the stable operating region 502 can have a stable area 506 and a threshold area 504. In the illustration shown in FIG. 5, the threshold area 504 (i.e., the crosshatched area) surrounds the stable area 506 (i.e., the non-crosshatched area). In the diagram shown in FIG. 5, it can be determined that data points within the stable operating region 502 correspond to operating conditions defined by linear velocity and angular velocity that enable the unmanned vehicle to maintain a stable operating state.

For example, data point 510 is within the stable area 506 of the operating region 502. Accordingly, operation conditions corresponding to data point 510 indicate a combination of linear velocity and angular velocity which correspond to the unmanned vehicle operating at a stable state. Data point 520 is outside of the stable operating region 502 and indicates a combination of angular velocity and linear velocity which correspond to the unmanned vehicle operating at an unstable state.

As the center of gravity of the unmanned vehicle moves (e.g., by moving the moveable mass), the shape of the stable operating region 502 is modified. In some embodiments, the vehicle processor 212 can adjust the stable operating region 502 automatically by determining the acceptable boundary for the current center of gravity. This can be determined from various different methods, including but not limited to, referencing one or more relevant tables related to various different positions of the moveable mass. For example, various stable operating regions can be determined for defined locations of the moveable mass (i.e., through prior testing). In operation, the vehicle processor 212 can determine which stable operating region 502 corresponds to the current position of the moveable mass. In some embodiments, the stable operating region 502 can be determined in real-time using parameterized calculations.

It will be understood that the shape of the stable operating region 502 shown in FIG. 5 is by way of example only. The shape defining the stable operating region 502 depends on various factors including, for example, the center of gravity of the unmanned vehicle, the configuration of the vehicle’s wheels (including the drive wheels), as well as the size, and shape of the vehicle’s payload stability triangle. It will further be understood that the axes for the stable operating region 502 (i.e., linear velocity and angular velocity) are also by way of example only. Other suitable parameters can be used to define the stable operating point for the unmanned vehicle given a particular center of gravity, such as but not limited to ground slope, tire condition, frame condition, and/or ground material.

At step 420, the vehicle processor 212 monitors the operating state of the unmanned vehicle 210 for an instability condition. An instability condition can be defined as, for example, the current operating state of the unmanned vehicle 210 being outside the allowable stable operating region. In some embodiments, operating the vehicle processor 212 to monitor for an instability condition includes determining a stable operating region for the unmanned vehicle 210 and determining the operating state of the vehicle fails to satisfy the stable operating region.

For example, in some embodiments, the vehicle processor 212 may detect an instability condition based on the current (or actual) operating state of the unmanned vehicle 210. The unmanned vehicle 210 may be actively operating at combination of angular and linear velocity that could lead to an instability condition. For example, the unmanned vehicle 210 may be in the process of turning and the vehicle processor 212 may detect an instability condition the if the current operating state of the unmanned vehicle 210 is on the edge of the stable operating region.

In some embodiments, the vehicle processor 212 may detect an instability condition based on a threshold. For example, as shown in FIG. 5, the stable operating region 502 for the unmanned vehicle 210 may include a threshold area 504. In some cases, the vehicle processor 212 may detect an instability condition if the current operating state of the unmanned vehicle 210 is within the threshold area 504.

In some embodiments, the vehicle processor 212 may detect an instability condition based on a future operating state of the unmanned vehicle 210. The unmanned vehicle 210 may perform a future action that could put the unmanned vehicle 210 in an operating state outside of the stable operating region. For example, the vehicle processor 212 may detect an instability condition by anticipating, prior to performing a turn, that the operating state of the unmanned vehicle 210 would be outside of the stable operating region when the turn is performed.

In some embodiments, operating the vehicle processor 212 to monitor for an instability condition includes collecting sensor data by one or more sensors coupled to the unmanned vehicle 210 and in communication with the vehicle processor 212. For example, one or more sensors coupled to the unmanned vehicle 210 can measure wheel speed. The vehicle processor 212 may detect an instability condition if it is determined that there is a loss of drive wheel traction. As another example, one or more sensors, such as an inertial measurement unit, coupled to the unmanned vehicle 210 can measure the vehicle’s lateral angle relative to the ground. The vehicle processor 212 may detect an instability condition if the lateral angle of the unmanned vehicle 210 exceeds a predetermined threshold.

At step 430, in response to detecting an instability condition, the vehicle processor 212 can determine a corrective response at the moveable mass for maintaining the stability of the unmanned vehicle 210. The vehicle processor 212 determines a corrective response involving an adjustment to the moveable mass. For example, the corrective response can be determined by calculating a distance the moveable mass needs to move from its initial position to shift the center of gravity. Shifting the center of gravity modifies the stable operating region for the unmanned vehicle 210 allowing for a different range of combinations of linear and angular velocity that can maintain stability for the unmanned vehicle 210 for its current operating state, its future operating state, or in response to active instability (e.g., tipping, loss of drive wheel traction).

At step 450, the vehicle processor 212 applies the corrective response to the moveable mass to maintain the stability of the unmanned vehicle 210. The vehicle processor 212 applies the corrective response by moving the moveable mass from the initial position. For example, the corrective response can be a binary motion (e.g., moving the moveable mass between two positions). The corrective response can be a discrete motion (e.g., moving the moveable mass to multiple specific positions). The corrective response can be continuous (e.g., moving the moveable mass to any position within the actuation range).

Referring to FIG. 6B, the example unmanned vehicle 610 is shown with the moveable mass 620 moved from its initial position (shown in FIG. 6A). The moveable 620 may be moved, for example, by a mechanism (not shown) configured to apply the corrective response to the moveable mass 620. The unmanned vehicle 610 and the moveable mass 620 have a combined center of gravity 630, which has shifted from its initial position shown in FIG. 6A.

In some embodiments, operating the vehicle processor 212 to apply the corrective response to the moveable mass includes activating an actuator secured to the unmanned vehicle 610. In some embodiments, the actuator may be a mechanism within the vehicle. The actuator can physically move the moveable mass within the unmanned vehicle 610. As a non-limiting example, the actuator can be one of a hydraulic piston, a pneumatic piston, a linear motor, a linear table with motor and screw, a rack and pinion, magnets, or a pump.

In some embodiments, operating the vehicle processor 212 to apply the corrective response to the moveable mass includes adjusting an orientation of the moveable mass. For example, the moveable mass can be rotated along the x-, y-, or z-axis to adjust the roll, pitch, or yaw of the moveable mass.

In some embodiments, the actuator can be part of an actuated system (e.g., a conveyor or a robot arm) configured to move a payload secured to the unmanned vehicle 210. In some embodiments, the payload can be the moveable mass.

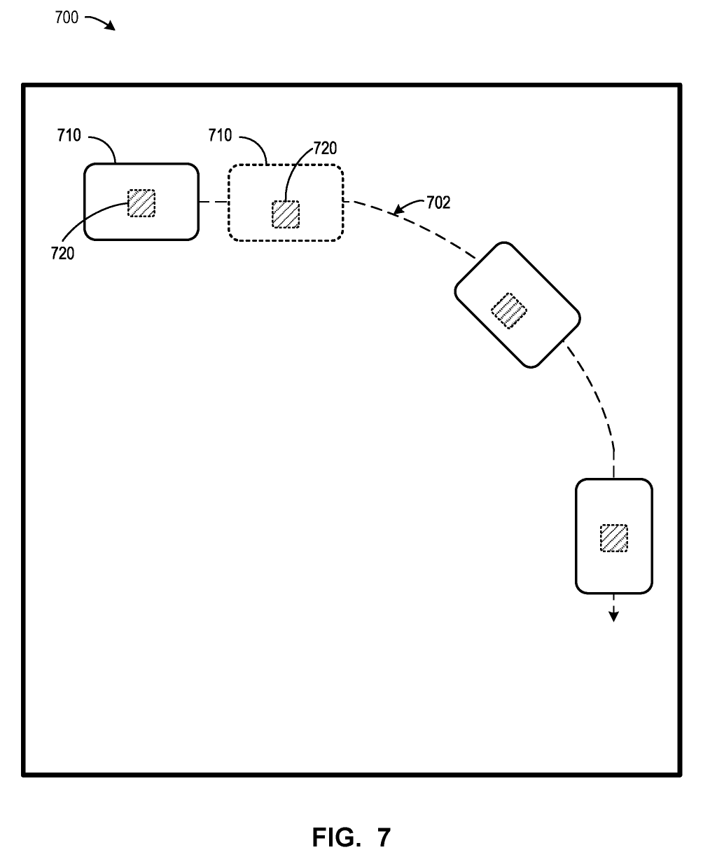

Referring to FIG. 7, there is an illustration of an example unmanned vehicle 710 turning with a moveable mass 720. The unmanned vehicle 710 navigates along vehicle path 702.

In some embodiments, operating the vehicle processor 212 to monitor the operating state of the unmanned vehicle 210 for an instability condition includes identifying an action from the received mission data. The vehicle processor 212 may determine that, when the action is performed, the unmanned vehicle 210 triggers an instability condition. For example, the received mission data may task a vehicle to perform a turn with a combination of linear and angular velocity defining an operating state that will be outside the stable operating region for the unmanned vehicle 210 for the given initial position of its moveable mass.

In some embodiments, in response to identifying the action that, when performed, triggers an instability condition, the vehicle processor 212 can, determine a corrective response at the moveable mass to maintain the stability of the unmanned vehicle. The vehicle processor 212 can apply the corrective response to the moveable mass prior to performing the action.

For example, as shown in FIG. 7, the processor may determine that the unmanned vehicle 710 will not be able follow the vehicle path 702 and perform a right turn with a given combination of linear and angular velocity for the center of gravity for the unmanned vehicle 710. In response, the vehicle processor may apply a corrective force to the moveable 720 to move the moveable mass from its initial position, prior to performing the right turn, to modify the stable operating region for the unmanned vehicle 710. As a result, unmanned vehicle 710 can perform the right turn without the risk of encountering an instability condition. In some embodiments, the moveable mass 720 returns to its initial position after the turn is performed.

In some embodiments, operating the vehicle processor 212 to apply the corrective response to the movable mass can include moving the moveable mass based on a predetermined sequence. The predetermined sequence can be defined by the mission data. For example, the mission data may outline a vehicle path including a series of turns to be performed by the unmanned vehicle 210 at predetermined combinations of linear velocity and angular velocity. The vehicle processor 212 may determine that, based on the initial position of the moveable mass for the unmanned vehicle 210, the operating state of the unmanned vehicle 210 will be outside the stable operating region if it attempted to perform the series of turns at the predetermined combinations of linear velocity and angular velocity. The vehicle processor 212 may apply a corrective response to the moveable mass to move the moveable mass in accordance with a predetermined sequence. The predetermined sequence can be synchronized with periods when the unmanned vehicle 210 is expected to perform a turn.

In some embodiments, the mission data includes historical data. The historical data can define one or more unstable locations along the vehicle path. For example, the historical data may indicate areas in a warehouse facility with poor surface conditions (e.g., low traction).

In some embodiments, the vehicle processor 212 can evaluate the historical data and determine a corrective response at the moveable mass sufficient to maintain stability of the unmanned vehicle 210 prior to entering the one or more unstable locations. For example, the unmanned vehicle 212 may determine the appropriate corrective response based on other unmanned vehicles that have previously navigated the one or more unstable locations. For instance, the unmanned vehicle 210 may determine a corrective response based on corrective responses applied to moveable masses for other unmanned vehicles that have successfully navigated the one or more unstable locations.

Unless the context requires otherwise, throughout the specification and claims which follow, the word “comprise” and variations thereof, such as, “comprises” and “comprising” are to be construed in an open, inclusive sense, that is, as “including, but not limited to.” It should be noted that terms of degree such as "substantially", "about" and “approximately" when used herein mean a reasonable amount of deviation of the modified term such that the end result is not significantly changed. These terms of degree should be construed as including a deviation of the modified term if this deviation would not negate the meaning of the term it modifies. In addition, as used herein, the wording “and/or” is intended to represent an inclusive or. That is, “X and/or Y” is intended to mean X or Y or both, for example. As a further example, “X, Y, and/or Z” is intended to mean X or Y or Z or any combination thereof. It should be noted that the term “coupled” used herein indicates that two elements can be directly coupled to one another or coupled to one another through one or more intermediate elements.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a keyboard, mouse, touchscreen, or the like), and at least one output device (e.g. a display screen, a printer, a wireless radio, or the like) depending on the nature of the device.

It should also be noted that there may be some elements that are used to implement at least part of one of the embodiments described herein that may be implemented via software that is written in a high-level computer programming language such as one that employs an object-oriented paradigm. Accordingly, the program code may be written in Java, C++ or any other suitable programming language and may include modules or classes, as is known to those skilled in object-oriented programming. Alternatively, or in addition thereto, some of these elements implemented via software may be written in assembly language, machine language or firmware as needed. In either case, the language may be a compiled or interpreted language.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail since these are known to those skilled in the art. Furthermore, it should be noted that this description is not intended to limit the scope of the embodiments described herein, but rather as describing exemplary implementations. Various modification and variations may be made to these example embodiments without departing from the spirit and scope of the invention, which is limited only by the appended claims.

1. A method of improving a stability of an unmanned vehicle having a moveable mass, the method comprising operating a processor at the unmanned vehicle to:
determine an initial center of gravity for the unmanned vehicle, the moveable mass being at an initial position;
define, for the initial center of gravity, a stable operating region characterized by a combination of linear and angular velocity for which the unmanned vehicle is expected to operate at a stable condition;
monitor an operating state of the unmanned vehicle for an instability condition, the instability condition corresponding to operating characteristics that fall outside the defined stable operating region; and
in response to detecting the instability condition:
determine a corrective position to which the moveable mass is moved to cause a subsequent center of gravity of the unmanned vehicle to enter a modified stable condition defined with respect to a modified stable operating region for the subsequent center of gravity, the modified stable operating region being characterized by a combination of linear velocity and angular velocity at which the unmanned vehicle operates at the modified stable condition;
generate the modified stable operating region for the subsequent center of gravity;
determine a corrective response at the unmanned vehicle for moving the moveable mass to the corrective position for maintaining the stability at the unmanned vehicle;
and apply the corrective response to the unmanned vehicle to shift the moveable mass to the corrective position so that the unmanned vehicle operates with respect to the modified stable operating region.

2. (canceled)

3. The method of claim 1, wherein operating the processor to monitor for the instability condition further comprises collecting sensor data by one or more sensors coupled to the unmanned vehicle and in communication with the processor.

4. The method of claim 1, further comprising operating the processor at the unmanned vehicle to receive mission data.

5. The method of claim 4, wherein operating the processor to monitor the operating state of the unmanned vehicle for the instability condition further comprises identifying an action from the received mission data, wherein the action, when performed, triggers the instability condition.

6. The method of claim 5, further comprising operating the processor to: in response to identifying the action:
determine the corrective response at the moveable mass to maintain the stability of the unmanned vehicle; and
apply the corrective response to the moveable mass prior to performing the action.

7. The method of claim 4, wherein the mission data comprises historical data defining one or more unstable locations.

8. The method of claim 7, wherein operating the processor to apply the corrective response further comprises applying the corrective response prior to entering the one or more unstable locations.

9. The method of claim 1, wherein operating the processor to apply the corrective response to the moveable mass further comprises activating an actuator secured to the unmanned vehicle.

10. The method of claim 1, wherein operating the processor to apply the corrective response to the moveable mass further comprises adjusting an orientation of the moveable mass.

11. A system of improving a stability of an unmanned vehicle having a moveable mass, the system comprising a processor at the unmanned vehicle operable to: determine an initial center of gravity for the unmanned vehicle, the moveable mass being at an initial position;
determine, for the initial center of gravity, a stable operating region characterized by a combination of linear and angular velocity for which the unmanned vehicle is expected to operate at a stable condition;
monitor an operating state of the unmanned vehicle for an instability condition, the instability condition corresponding to operating characteristics that fall outside the defined stable operating region;
in response to detecting the instability condition:
determine a corrective position to which the moveable mass is moved to cause a subsequent center of gravity of the unmanned vehicle to enter a modified stable condition defined with respect to a modified stable operating region for the subsequent center of gravity, the modified stable operating region being characterized by a combination of linear velocity and angular velocity at which the unmanned vehicle operates at the modified stable condition;
generate the modified stable operating region for the subsequent center of gravity;
determine a corrective response at the unmanned vehicle for moving the moveable mass to the corrective position; and
apply the corrective response to the unmanned vehicle to shift the moveable mass to the corrective position so that the unmanned vehicle operates with respect to the modified stable operating region.

12. (canceled)

13. The system of claim 11, wherein monitoring for the instability condition further comprises operating the processor to collect sensor data by one or more sensors coupled to the unmanned vehicle and in communication with the processor.

14. The system of claim 11, wherein the processor at the unmanned vehicle is further operable to receive mission data.

15. The system of claim 14, wherein monitoring the operating state of the unmanned vehicle for the instability condition further comprises operating the processor to identify an action from the received mission data, the action, when performed, triggers the instability condition.

16. The system of claim 15, wherein the processor is further operable to: in response to identifying the action:
determine the corrective response at the moveable mass to maintain the stability of the unmanned vehicle; and
apply the corrective response to the moveable mass prior to performing the action.

17. The system of claim 14, wherein the mission data comprises historical data defining one or more unstable locations.

18. The system of claim 17, wherein applying the corrective response further comprises applying the corrective response prior to entering the one or more unstable locations.

19. The system of claim 11, wherein applying the corrective response to the moveable mass further comprises operating the processor to activate an actuator secured to the unmanned vehicle.

20. The system of claim 11, wherein applying the corrective response to the moveable mass further comprises operating the processor to adjust an orientation of the moveable mass.

21. The method of claim 1, further comprising evaluating the modified stable operating region by determining whether the operating state is within an acceptable boundary of the modified stable operating region.

22. The system of claim 11, wherein the processor is further operable to: evaluate the modified stable operating region by determining whether the operating state is within an acceptable boundary of the modified stable operating region.
